(19) United States
(12) Patent Application Publication
(10) Pub. No.: US 2005/0031079 A1
(43) Pub. Date: Feb. 10, 2005

(54) Radiographic apparatus and radiation detection signal processing method

(76) Inventors: Shoichi Okamura, Nara-ken (JP); Keiichi Fujii, Kyoto-fu (JP); Susumu Adachi, Osaka-fu (JP); Shinya Hirasawa, Kyoto-fu (JP); Toshinori Yoshimuta, Osaka-fu (JP); Koichi Tanabe, Kyoto-fu (JP); Shigeya Asai, Kyoto-fu (JP); Akihiro Nishimura, Kyoto-fu (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/885,634

(22) Filed: Jul. 8, 2004

(30) Foreign Application Priority Data
Jul. 9, 2003 (JP) JP2003-272520

(51) Int. Cl. H05G 1/08

(52) U.S. Cl. 378/91

(57) ABSTRACT

A radiographic apparatus removes lag-behind parts from radiation detection signals taken from an FPD as X rays are emitted from an X-ray tube, on an assumption that the lag-behind part included in each X-ray detection signal is due to an impulse response formed of a plurality of exponential functions with different attenuation time constants. The lag-behind parts are removed by using impulse responses of the FPD corresponding, for example, to an X-ray dose used in a fluoroscopic image pickup and an X-ray dose used in a radiographic image pickup. X-ray images are created from corrected radiation detection signals with the lag-behind parts removed therefrom.

### BACKGROUND OF THE INVENTION

(1) Field of the Invention

This invention relates to a radiographic apparatus for medical or industrial use and a radiation detection signal processing method, for obtaining radiographic images based on radiation detection signals fetched at predetermined sampling time intervals by a signal sampling device from a radiation detecting device as radiation is emitted from a radiation emitting device. More particularly, the invention relates to a technique for fully eliminating time lags, due to the radiation detecting device, of the radiation detection signals taken from the radiation detecting device.

(2) Description of the Related Art

In a medical fluoroscopic apparatus which is a typical example of radiographic apparatus, a flat panel X-ray detector (hereinafter called “FPD” as appropriate) has recently been used as an X-ray detecting device for detecting X-ray penetration images of a patient resulting from X-ray emission from an X-ray tube. The FPD includes numerous semiconductor or other X-ray detecting elements arranged longitudinally and transversely on an X-ray detecting surface.

That is, in the fluoroscopic apparatus, X-ray detection signals for one X-ray image are taken at sampling time intervals from the FPD as a patient is irradiated with X rays from the X-ray tube. The fluoroscopic apparatus is constructed to obtain, based on the X-ray detection signals, an X-ray image corresponding to an X-ray penetration image of the patient for every period between sampling intervals. The use of the FPD is advantageous in terms of apparatus construction and image processing since the FPD is lighter and less prone to complicated detecting distortions than the image intensifier used heretofore.

However, the FPD has a drawback of causing time lags whose adverse influence appears in X-ray images. Specifically, when X-ray detection signals are taken from the FPD at short sampling time intervals, the remainder of a signal not picked up adds to a next X-ray detection signal as a lag-behind part. Thus, where X-ray detection signals for one image are taken from the FPD at 30 sampling intervals per second to create X-ray images for dynamic display, the lag-behind part appears as an after-image on a preceding screen to produce a double image. This results in an inconvenience such as blurring of dynamic images.

U.S. Pat. No. 5,249,123 discloses a proposal to solve the problem of the time lag caused by the FPD in acquiring computer tomographic images (CT images). This proposed technique employs a computation for eliminating a lag-behind part from each of radiation detection signals taken from an FPD at sampling time intervals Δt.

That is, in the above U.S. patent, a lag-behind part included in each of the radiation detection signals taken at the sampling time intervals is assumed due to an impulse response formed of a plurality of exponential functions, and the following equation is used to derive radiation detection signal xₖ with a lag-behind part removed from radiation detection signal yₖ:
xₖ=[yₖ−Σₙ₌₁^{N}{αₙ·[1−exp(Tₙ)]·exp(Tₙ)·Sₙₖ}]/Σₙ₌₁^{N}βₙ
in which Tₙ=−Δτₙ, Sₙₖ=xₖ₋₁+exp(Tₙ)·Sₙ₍ₖ₋₁₎, and βₙ=αₙ·[1−exp(Tₙ),
   where Δt: sampling intervals;
k: subscript representing a k-th point of time in a sampling time series;
N: the number of exponential functions with different time constants forming the impulse response;
n: subscript representing one of the exponential functions forming the impulse response;
αₙ: intensity of exponential function n; and
τₙ: attenuation time constant of exponential function n.

Inventors herein have tried the computation technique proposed in the above U.S. patent. However, the only result obtained is that the above technique cannot avoid artifacts due to the time lag and satisfactory X-ray images cannot be obtained. It has been confirmed that the time lag due to the FPD is not eliminated.

Further, U.S. Pat. No. 5,517,544 discloses a different proposal to solve the problem of the time lag caused by the FPD in acquiring CT images. This technique assumes a time lag of the FPD to be approximated by one exponential function, and removes a lag-behind part from a radiation detection signal by computation. Inventors herein have carefully reviewed the computation technique proposed in this U.S. patent. It has been found, however, that it is impossible for one exponential function to approximate the time lag of the FPD, and the time lag is not eliminated by this technique, either.

### SUMMARY OF THE INVENTION

This invention has been made having regard to the state of the art noted above, and its object is to provide a radiographic apparatus and a radiation detection signal processing method for fully eliminating time lags, due to a radiation detecting device, of radiation detection signals taken from the radiation detecting device.

The following technique is conceivable to solve the above problem. In dealing with the time lag of the FPD, this technique removes a lag-behind part due to an impulse response based on the following recursive equations A-C:
Xₖ=Yₖ−Σₙ₌₁^{N}{αₙ·[1−exp(Tₙ)]·exp(Tₙ)·Sₙₖ} a
Tₙ=Δt/τₙ b
Sₙₖ=Xₖ₋₁+exp(Tₙ)·Sₙ₍ₖ₋₁₎ c
where Δt: the sampling time interval;
k: a subscript representing a k-th point of time in a sampling time series;
Yₖ: an X-ray detection signal taken at the k-th sampling time;
Xₖ: a corrected X-ray detection signal with a lag-behind part removed from the signal Yₖ;
Xₖ₋₁: a signal Xₖ taken at a preceding point of time;
Sₙ₍ₖ₋₁₎: an Sₙₖ at a preceding point of time;
exp: an exponential function;
N: the number of exponential functions with different time constants forming the impulse response;
n: a subscript representing one of the exponential functions forming the impulse response;
αₙ: an intensity of exponential function n; and
ρₙ: an attenuation time constant of exponential function n.

In the above recursive computation, coefficients of the impulse response of the FPD, N, αₙ and τₙ, are determined in advance. With the coefficients fixed, X-ray detection signal Yₖ is applied to equations a-c, thereby obtaining a lag-free X-ray detection signal Xₖ.

The technique described above is effective where an impulse response causing a time delay is invariable at all times, but is otherwise inadequate.

FIG. 7 is a view showing a state of radiation incidence. FIG. 8 is a view showing time delays corresponding to the radiation incidence in FIG. 7. In these figures, time t0-t1 has an incidence of a fluoroscopic dose of radiation, while time t2-t3 has an incidence of radiographic dose of radiation.

As shown in FIG. 7, an incidence of X rays takes place during time t0-t1 and time t2-t3, lag-behind parts shown in hatching in FIG. 8 add to normal signals corresponding to the incident doses. This results in radiation detection signals Yk shown in thick lines in FIG. 8.

If an impulse response is invariable regardless of incident doses, the above technique may be used to remove the lag-behind parts, i.e. the hatched portions in FIG. 8, to obtain proper signals.

However, Inventors herein have the findings that the impulse response of an FPD is variable with the incident dose of X rays. It has been found that lag-behind parts cannot be removed complexly or accurately where major variations occur in the incident dose, such as with switching between fluoroscopy and radiography as shown in FIG. 7.

Based on the above findings, this invention provides a radiographic apparatus having a radiation emitting device for emitting radiation toward an object under examination, a radiation detecting device for detecting radiation transmitted through the object under examination, and a signal sampling device for taking radiation detection signals from the radiation detecting device at predetermined sampling time intervals, for obtaining radiographic images based on the radiation detection signals outputted from the radiation detecting device at the predetermined sampling time intervals as radiation is emitted to the object under examination, the apparatus comprising:
a time lag removing device for removing lag-behind parts from the radiation detection signals by a recursive computation, on an assumption that a lag-behind part included in each of the radiation detection signals taken at the predetermined sampling time intervals is due to an impulse response formed of a plurality of exponential functions with different attenuation time constants;
wherein the time lag removing device is arranged to determine the impulse response based on a dose of radiation, and obtain a corrected radiation detection signal by removing the lag-behind part based on the impulse response corresponding to the dose.

With the radiographic apparatus according to this invention, radiation detection signals are outputted from the radiation detecting device at predetermined sampling time intervals as radiation is emitted from the radiation emitting device to an object under examination. A lag-behind part included in each of the radiation detection signals is regarded as due to an impulse response formed of a plurality of exponential functions with different attenuation time constants. The time lag removing device removes such lag-behind parts by using impulse responses corresponding to doses of radiation. A radiographic image is obtained from corrected radiation detection signals with the lag-behind parts removed.

Thus, with the radiographic apparatus according to the invention, the impulse response is determined based on a dose of radiation when the time lag removing device computes a corrected radiation detection signal by removing a lag-behind part from each radiation detection signal. The computation is performed based on the impulse response corresponding to the dose of radiation. The corrected radiation detection signal computed in this way is free from errors due to variations in the dose of radiation, and has the lag-behind part fully removed therefrom.

In the above radiographic apparatus, the time lag removing device, preferably, is arranged to perform the recursive computation for removing the lag-behind part from each of the radiation detection signals, based on the following equations A-E:

$$\begin{matrix}\begin{matrix}{X}_{k} = {Y}_{k} - \{ {{\sum }_{n [ 1 ] = 1}}^{N [ 1 ]} [ {α}_{n [ 1 ]} \cdot [ 1 - exp ( {T}_{n [ 1 ]} ) ] \cdot exp ( {T}_{n [ 1 ]} ) \cdot {S}_{n [ 1 ] k} ] + \\ {{\sum }_{n [ 2 ] = 1}}^{N [ 2 ]} [ {α}_{n [ 2 ]} \cdot [ 1 - exp ( {T}_{n [ 2 ]} ) ] \cdot exp ( {T}_{n [ 2 ]} ) \cdot {S}_{n [ 2 ] k} ] + … + \\ {{\sum }_{n [ h ] = 1}}^{N [ h ]} [ {α}_{n [ h ]} \cdot [ 1 - exp ( {T}_{n [ h ]} ) ] \cdot exp ( {T}_{n [ h ]} ) \cdot {S}_{n [ h ] k} ] + … + \\ {{\sum }_{n [ H ] = 1}}^{N [ H ]} [ {α}_{n [ H ]} \cdot [ 1 - exp ( {T}_{n [ H ]} ) ] \cdot exp ( {T}_{n [ H ]} ) \cdot {S}_{n [ H ] k} ] + \} \\ = {Y}_{k} - \{ {U}_{n [ 1 ]} + {U}_{n [ 2 ]} + … + \\ {U}_{n [ h ]} … + {U}_{n [ H ]} \} = {Y}_{k} - {\sum }_{h = 1}^{H} [ {U}_{n [ h ]} ]\end{matrix} & A \\ {T}_{n [ h ]} = - Δ t / {τ}_{n [ h ]} & B \\ {S}_{n [ j ] k} = {X}_{k - 1} + exp ( {T}_{n [ j ]} ) \cdot {S}_{n [ j ] k - 1} ( in time of j = h ) & C \\ {S}_{n [ j ] k} = exp ( {T}_{n [ j ]} ) \cdot {S}_{n [ j ] k - 1} ( in time of j \neq h ) & D \\ {U}_{n [ h ]} = {\sum }_{n [ h ] = 1}^{N [ h ]} [ {α}_{n [ h ]} \cdot [ 1 - exp ( {T}_{n [ h ]} ) ] \cdot exp ( {T}_{n [ h ]} ) \cdot {S}_{n [ h ] k} ] & E\end{matrix}$$

where Δt: the sampling time interval;
k: a subscript representing a k-th point of time in a sampling time series;
Yₖ: an X-ray detection signal taken at the k-th sampling time;
Xₖ: a corrected X-ray detection signal with a lag-behind part removed from the signal Yₖ;
Xₖ₋₁: a signal Xₖ taken at a preceding point of time;
Sₙ₍ₖ₋₁₎: an Sₙₖ at a preceding point of time;
exp: an exponential function;
H: type of dose;
h: condition of a dose at a current point of time among H doses;
j: a subscript representing a given dose among the H doses;
N[h]: the number of exponential functions with different time constants forming the impulse response in time of dose h;
n[h]: a subscript representing one of the exponential functions forming the impulse response in time of dose h;
U_{n[h]}: a time lag in time of dose h;
α_{n[h]}: an intensity of exponential function n; and
τ_{n[h]}: an attenuation time constant of exponential function n;
   and obtain the corrected radiation detection signal by removing the lag-behind part based on the impulse response derived from the equations A-E.

Where the recursive computation for removing the lag-behind part from each of the radiation detection signals is based on equations A-E, the corrected, lag-free X-ray detection signal Xₖ may be derived promptly from equations A-E constituting a compact recurrence formula. That is, where, as shown in FIG. 7, a certain quantity of radiation impinges on the radiation detecting device during each of time t0-t1 and time t2-t3, a radiation detection signal will have a certain value in the absence of a time lag occurring with the radiation detecting device as shown in FIG. 8.

In practice, however, a time lag occurs with the radiation detecting device, adding a lag-behind part shown in hatching in FIG. 8. This results in radiation detection signal Yₖ shown in a thick line in FIG. 8. In the radiographic apparatus according to this invention, the second and subsequent terms on the right-hand side of equation A, i.e. equation E “U_{n[h]}=Σ_{n[h]=1}^{N[h]}[α_{n[h]}·[1−exp(T_{n[h]})]·exp(T_{n[h]})·S_{n[h]k}]” correspond to each lag-behind part shown in hatching in FIG. 8. This is subtracted from radiation detection signal Yₖ, resulting in the corrected, lag-free X-ray detection signal Xₖ without the lag-behind part shown in FIG. 7.

Where the number of different radiation doses is H, a different impulse response corresponding to each dose is expected to occur. Thus, when an image is picked up at the current time k with condition h of one of the H doses, an impulse response corresponding to the other dose, while attenuating, will have an overlapping effect as shown in FIG. 8. Thus, S_{n[h]k} is computed simultaneously as in equations C and D according to the respective doses, and corrected radiation detection signal Xₖ is computed by substituting S_{n[j]k} obtained into equation A. However, corrected radiation detection signal Xₖ, which is a veritable radiation detection signal, exists in time of j=h when an image is actually picked up, but does not exist in time of image pickup with the other dose when an image is not actually picked up, i.e. in time of j≠h. Thus, Xₖ is included in equation C, i.e. in time of j=h, and is not included in equation D, i.e. in time of j≠h. With such equations A-E, dose changes are taken into account for fully removing the lag-behind parts.

In order to remove the lag-behind parts with increased accuracy, it is preferred that a scaling before and after a change in conditions of the dose is performed based on the following equations F and G with the scaling added to the equations C and D:
S_{n[j]i}=M·{Xᵢ₋₁+exp(T_{n[j]})·S_{n[j](i-1)}} (in time of j=h) F
S_{n[j]i}=exp(T_{n[j]})·S_{n[j](i-1)}} (in time of j≠h) G
where i−1: a subscript representing a point of time immediately before the dose change;
i: a subscript representing a point of time immediately after the dose change; and
M: a scaling ratio which is a ratio between values taken before and after the dose change.

Where a scaling is taken into account, before and after a switching of radiation dose conditions k=i−1 and K=i, a scaling is performed based on a scaling ratio between values taken before and after the dose change. This produces the effect of removing the lag-behind parts with increased accuracy.

In the radiographic apparatus, one example of the radiation detecting device is a flat panel X-ray detector having numerous X-ray detecting elements arranged longitudinally and transversely on an X-ray detecting surface.

The radiographic apparatus according to this invention may be a medical apparatus, and an apparatus for industrial use as well. An example of medical apparatus is a fluoroscopic apparatus. Another example of medical apparatus is an X-ray CT apparatus. An example of apparatus for industrial use is a nondestructive inspecting. apparatus.

In another aspect of the invention, a radiation detection signal processing method is provided for taking, at predetermined sampling time intervals, radiation detection signals generated by irradiating an object under examination, and performing a signal processing to obtain radiographic images based on the radiation detection signals outputted at the predetermined sampling time intervals, the method comprising the steps of:
removing lag-behind parts from the radiation detection signals by a recursive computation, on an assumption that a lag-behind part included in each of the radiation detection signals taken at the predetermined sampling time intervals is due to an impulse response formed of a plurality of exponential functions with different attenuation time constants;
determining the impulse response based on a dose of radiation; and
obtaining a corrected radiation detection signal by removing the lag-behind part based on the impulse response corresponding to the dose.

This radiation detection signal processing method allows the radiographic apparatus according to the invention to be implemented in an advantageous manner.

In the above radiation detection signal processing method, the recursive computation, preferably, is performed for removing the lag-behind part from each of the radiation detection signals, based on the following equations A-E:

$$\begin{matrix}\begin{matrix}{X}_{k} = {Y}_{k} - \{ {{\sum }_{n [ 1 ] = 1}}^{N [ 1 ]} [ {α}_{n [ 1 ]} \cdot [ 1 - exp ( {T}_{n [ 1 ]} ) ] \cdot exp ( {T}_{n [ 1 ]} ) \cdot {S}_{n [ 1 ] k} ] + \\ {{\sum }_{n [ 2 ] = 1}}^{N [ 2 ]} [ {α}_{n [ 2 ]} \cdot [ 1 - exp ( {T}_{n [ 2 ]} ) ] \cdot exp ( {T}_{n [ 2 ]} ) \cdot {S}_{n [ 2 ] k} ] + … + \\ {{\sum }_{n [ h ] = 1}}^{N [ h ]} [ {α}_{n [ h ]} \cdot [ 1 - exp ( {T}_{n [ h ]} ) ] \cdot exp ( {T}_{n [ h ]} ) \cdot {S}_{n [ h ] k} ] + … + \\ {{\sum }_{n [ H ] = 1}}^{N [ H ]} [ {α}_{n [ H ]} \cdot [ 1 - exp ( {T}_{n [ H ]} ) ] \cdot exp ( {T}_{n [ H ]} ) \cdot {S}_{n [ H ] k} ] + \} \\ = {Y}_{k} - \{ {U}_{n [ 1 ]} + {U}_{n [ 2 ]} + … + \\ {U}_{n [ h ]} … + {U}_{n [ H ]} \} = {Y}_{k} - {\sum }_{h = 1}^{H} [ {U}_{n [ h ]} ]\end{matrix} & A \\ {T}_{n [ h ]} = - Δ t / {τ}_{n [ h ]} & B \\ {S}_{n [ j ] k} = {X}_{k - 1} + exp ( {T}_{n [ j ]} ) \cdot {S}_{n [ j ] k - 1} ( in time of j = h ) & C \\ {S}_{n [ j ] k} = exp ( {T}_{n [ j ]} ) \cdot {S}_{n [ j ] k - 1} ( in time of j \neq h ) & D \\ {U}_{n [ h ]} = {\sum }_{n [ h ] = 1}^{N [ h ]} [ {α}_{n [ h ]} \cdot [ 1 - exp ( {T}_{n [ h ]} ) ] \cdot exp ( {T}_{n [ h ]} ) \cdot {S}_{n [ h ] k} ] & E\end{matrix}$$

where Δt: the sampling time interval;
k: a subscript representing a k-th point of time in a sampling time series;
Yₖ: an X-ray detection signal taken at the k-th sampling time;
Xₖ: a corrected X-ray detection signal with a lag-behind part removed from the signal Yₖ;
Xₖ₋₁: a signal Xₖ taken at a preceding point of time;
Sₙ₍ₖ₋₁₎: an Sₙₖ at a preceding point of time;
exp: an exponential function;
H: type of dose;
h: condition of a dose at a current point of time among H doses;
j: a subscript representing a given dose among the H doses;
N[h]: the number of exponential functions with different time constants forming the impulse response in time of dose h;
n[h]: a subscript representing one of the exponential functions forming the impulse response in time of dose h;
U_{n[h]}: a time lag in time of dose h;
α_{n[h]}: an intensity of exponential function n; and
τ_{n[h]}: an attenuation time constant of exponential function n;
   and obtain the corrected radiation detection signal by removing the lag-behind part based on the impulse response derived from the equations A-E.

Where the recursive computation for removing the lag-behind part from each of the radiation detection signals is based on equations A-E, the radiographic apparatus that performs the recursive computation based on equations A-E may be implemented advantageously.

In order to remove the lag-behind parts with increased accuracy, it is preferred that a scaling before and after a change in conditions of the dose is performed based on the following equations F and G with the scaling added to the equations C and D:
S_{n[j]i}=M·{Xᵢ₋₁+exp(T_{n[j])·}S_{n[j](i-1)}} (in time of j=h) F
S_{n[j]i}=exp(T_{n[j]})·S_{n[j](i-1)} (in time of j≠h) G
where i−1: a subscript representing a point of time immediately before the dose change;

i: a subscript representing a point of time immediately after the dose change; and
M: a scaling ratio which is a ratio between values taken before and after the dose change.

Where a scaling is taken into account, the radiographic apparatus that performs a scaling may be implemented advantageously.

In one example of the radiation detection signal processing method according to this invention, a series of image pickups including at least a fluoroscopic image pickup and a radiographic image pickup using different doses of radiation is performed, the impulse response being determined from the dose of radiation for each image pickup, and the corrected radiation detection signal being obtained by removing the lag-behind part based on the impulse response corresponding to the dose, thereby obtaining radiographic images.

With this method, the lag-behind parts are fully removed in the series of image pickups including at least a fluoroscopic image pickup and a radiographic image pickup using different doses of radiation.

The series of image pickups may be performed in an order from fluoroscopy to radiography and to fluoroscopy again, or from fluoroscopy to radiography only. In one example of the series of image pickups performed in the order from fluoroscopy to radiography, the order is from fluoroscopy to radiography of the head, from radiography of the head to radiography of the chest, from radiography of the chest to radiography of the abdomen, from radiography of the abdomen to radiography to the leg, and from the radiography of the leg to fluoroscopy.

In an example of switching between the fluoroscopic image pickup and the radiographic image pickup, a switching is made of amplitudes of a radiation emitting device for emitting radiation toward the object under examination.

In another example of the radiation detection signal processing method according to this invention, a series of image pickups including at least imaging of different sites using different doses of radiation is performed, the impulse response being determined from the dose of radiation for each image pickup, and the corrected radiation detection signal being obtained by removing the lag-behind part based on the impulse response corresponding to the dose, thereby obtaining radiographic images.

With this method, the lag-behind parts are fully removed in the series of image pickups including at least imaging of different sites using different doses of radiation.

The different sites are the head, chest, abdomen and leg, for example.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a block diagram showing an overall construction of a fluoroscopic apparatus according to the invention;

FIG. 2 is a plan view of an FPD used in the fluoroscopic apparatus;

FIG. 3 is a schematic view showing a state of sampling X-ray detection signals during X-ray radiography by the fluoroscopic apparatus;

FIG. 4 is a flow chart showing a procedure of an X-ray detection signal processing method according to this invention;

FIG. 5 is a flow chart showing a recursive computation process for time lag removal in the X-ray detection signal processing method according to this invention;

FIG. 6 is a view showing a series of image pickup stages in X-ray radiography;

FIG. 7 is a view showing a state of radiation incidence; and

FIG. 8 is a view showing time lags corresponding to the radiation incidence in FIG. 7.

### DESCRIPTION OF THE PREFERRED EMBODIMENTS

Preferred embodiments of this invention will be described in detail hereinafter with reference to the drawings.

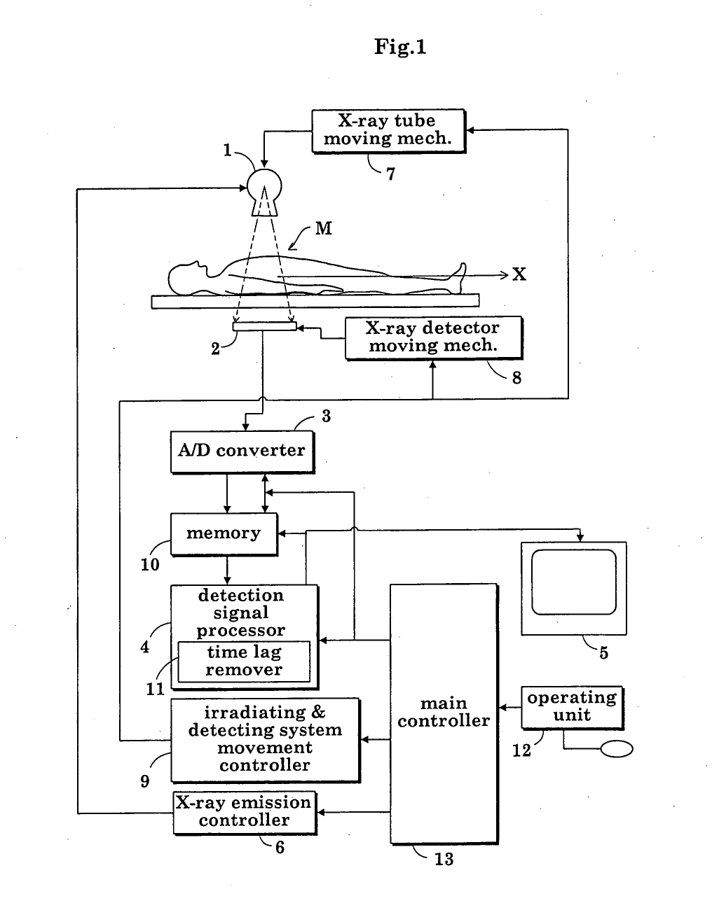

FIG. 1 is a block diagram showing an overall construction of a fluoroscopic apparatus according to this invention.

As shown in FIG. 1, the fluoroscopic apparatus includes an X-ray tube (radiation emitting device) 1 for emitting X rays toward a patient M, an FPD 2 (radiation detecting device) for detecting X rays transmitted through the patient M, an analog-to-digital converter 3 (signal sampling device) for digitizing X-ray detection signals (radiation detection signals) taken from the FPD (flat panel X-ray detector) 2 at predetermined sampling time intervals At, a detection signal processor 4 for creating X-ray images based on X-ray detection signals outputted from the analog-to-digital converter 3, and an image monitor 5 for displaying the X-ray images created by the detection signal processor 4. That is, the apparatus is constructed to acquire X-ray images from the X-ray detection signals taken from the FPD 2 by the analog-to-digital converter 3 as the patient M is irradiated with X rays, and display the acquired X-ray images on the screen of the image monitor 5. Each component of this apparatus will particularly be described hereinafter.

The X-ray tube 1 and FPD 2 are opposed to each other across the patient M. In time of X-ray radiography, the X-ray tube 1 is controlled by an X-ray emission controller 6 to emit X rays in the form of a cone beam to the patient M. At the same time, penetration X-ray images of the patient M produced by the X-ray emission are projected to an X-ray detecting surface of FPD 2.

The X-ray tube 1 and FPD 2 are movable back and forth along the patient M by an X-ray tube moving mechanism 7 and an X-ray detector moving mechanism 8, respectively. In moving the X-ray tube 1 and FPD 2, the X-ray tube moving mechanism 7 and X-ray detector moving mechanism 8 are controlled by an irradiating and detecting system movement controller 9 to move the X-ray tube 1 and FPD 2 together as opposed to each other, with the center of emission of X rays constantly in agreement with the center of the X-ray detecting surface of FPD 2. Of course, movement of the X-ray tube 1 and FPD 2 results in variations in the position of the patient M irradiated with X rays, hence movement of a radiographed site.

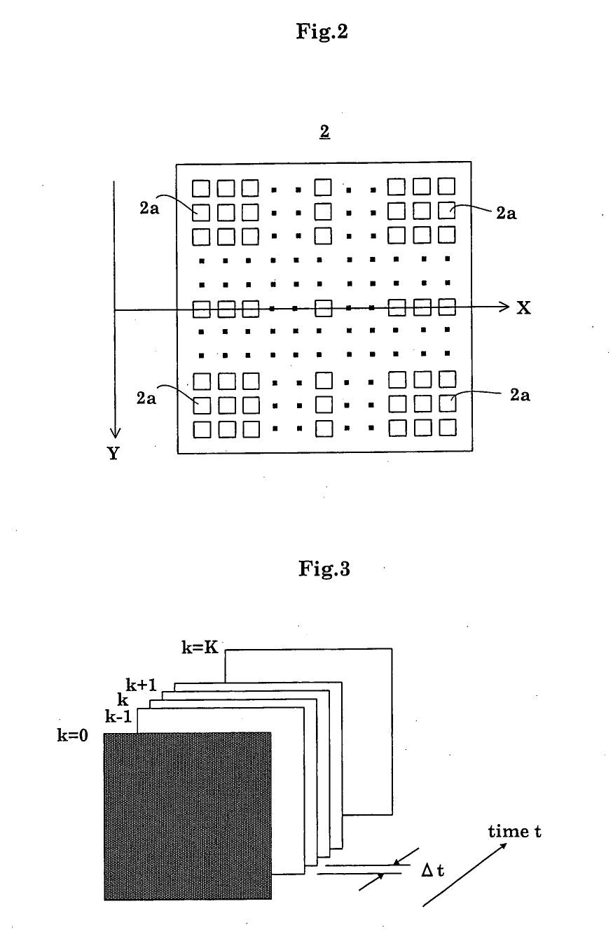

As shown in FIG. 2, the FPD 2 has numerous X-ray detecting elements 2a arranged longitudinally and transversely along the direction X of the body axis of patient M and the direction Y perpendicular to the body axis, on the X-ray detecting surface to which penetration X-ray images from the patient M are projected. For example, X-ray detecting elements 2a are arranged to form a matrix of 1536 by 1536 on the X-ray detecting surface about 30 cm long and 30 cm wide. Each X-ray detecting element 2a of FPD 2 corresponds to one pixel in an X-ray image created by the detection signal processor 4. Based on the X-ray detection signals taken from the FPD 2, the detection signal processor 4 creates an X-ray image corresponding to a penetration X-ray image projected to the X-ray detecting surface.

The analog-to-digital converter 3 continually takes X-ray detection signals for each X-ray image at sampling time intervals Δt, and stores the X-ray detection signals for X-ray image creation in a memory 10 disposed downstream of the converter 3. An operation for sampling (extracting) the X-ray detection signals is started before X-ray irradiation.

That is, as shown in FIG. 3, all X-ray detection signals for a penetration X-ray image are collected at each period between the sampling intervals Δt, and are successively stored in the memory 10. The sampling of X-ray detection signals by the analog-to-digital converter 3 before an emission of X rays may be started manually by the operator or automatically as interlocked with a command for X-ray emission.

As shown in FIG. 1, the fluoroscopic apparatus in this embodiment includes a time lag remover 11 for computing corrected radiation detection signals free from time lags. A time lag is removed from each X-ray detection signal by a recursive computation based on an assumption that a lag-behind part included in each of the X-ray detection signals taken at the sampling time intervals from the FPD 2 is due to an impulse response formed of a plurality of exponential functions with different attenuation time constants.

With the FPD 2, an X-ray detection signal generated at each point of time, as shown in FIG. 8, includes signals corresponding to preceding X-ray emissions and remaining as a lag-behind part (hatched part). The time lag remover 11 removes this lag-behind part to produce a corrected, lag-free X-ray detection signal. Based on such lag-free X-ray detection signals, the detection signal processor 4 creates an X-ray image corresponding to a penetration X-ray image to be projected to the X-ray detecting surface.

Specifically, the time lag remover 11 performs a recursive computation processing for removing a lag-behind part from each X-ray detection signal by using the following equations A-E:

$$\begin{matrix}\begin{matrix}{X}_{k} = {Y}_{k} - \{ {{\sum }_{n [ 1 ] = 1}}^{N [ 1 ]} [ {α}_{n [ 1 ]} \cdot [ 1 - exp ( {T}_{n [ 1 ]} ) ] \cdot exp ( {T}_{n [ 1 ]} ) \cdot {S}_{n [ 1 ] k} ] + \\ {{\sum }_{n [ 2 ] = 1}}^{N [ 2 ]} [ {α}_{n [ 2 ]} \cdot [ 1 - exp ( {T}_{n [ 2 ]} ) ] \cdot exp ( {T}_{n [ 2 ]} ) \cdot {S}_{n [ 2 ] k} ] + … + \\ {{\sum }_{n [ h ] = 1}}^{N [ h ]} [ {α}_{n [ h ]} \cdot [ 1 - exp ( {T}_{n [ h ]} ) ] \cdot exp ( {T}_{n [ h ]} ) \cdot {S}_{n [ h ] k} ] + … + \\ {{\sum }_{n [ H ] = 1}}^{N [ H ]} [ {α}_{n [ H ]} \cdot [ 1 - exp ( {T}_{n [ H ]} ) ] \cdot exp ( {T}_{n [ H ]} ) \cdot {S}_{n [ H ] k} ] + \} \\ = {Y}_{k} - \{ {U}_{n [ 1 ]} + {U}_{n [ 2 ]} + … + \\ {U}_{n [ h ]} … + {U}_{n [ H ]} \} = {Y}_{k} - {\sum }_{h = 1}^{H} [ {U}_{n [ h ]} ]\end{matrix} & A \\ {T}_{n [ h ]} = - Δ t / {τ}_{n [ h ]} & B \\ {S}_{n [ j ] k} = {X}_{k - 1} + exp ( {T}_{n [ j ]} ) \cdot {S}_{n [ j ] k - 1} ( in time of j = h ) & C \\ {S}_{n [ j ] k} = exp ( {T}_{n [ j ]} ) \cdot {S}_{n [ j ] k - 1} ( in time of j \neq h ) & D \\ {U}_{n [ h ]} = {\sum }_{n [ h ] = 1}^{N [ h ]} [ {α}_{n [ h ]} \cdot [ 1 - exp ( {T}_{n [ h ]} ) ] \cdot exp ( {T}_{n [ h ]} ) \cdot {S}_{n [ h ] k} ] & E\end{matrix}$$

where Δt: the sampling time interval;
k: a subscript representing a k-th point of time in a sampling time series;
Yₖ: an X-ray detection signal taken at the k-th sampling time;
Xₖ: a corrected X-ray detection signal with a lag-behind part removed from the signal Yₖ;
Xₖ₋₁: a signal Xₖ taken at a preceding point of time;
Sₙ₍ₖ₋₁₎: an Sₙₖ at a preceding point of time;
exp: an exponential function;
H: type of dose;
h: condition of a dose at a current point of time among H doses;
j: a subscript representing a given dose among the H doses;
N[h]: the number of exponential functions with different time constants forming the impulse response in time of dose h;
n[h]: a subscript representing one of the exponential functions forming the impulse response in time of dose h;
U_{n[h]}: a time lag in time of dose h;
α_{n[h]}: an intensity of exponential function n; and
τ_{n[h]}: an attenuation time constant of exponential function n.

The second and subsequent terms on the right-hand side of equation A, i.e. equation E “U_{n[h]}=Σ_{n[h]=1}^{N[h]}[α_{n[h]}·[−exp(T_{n[h]})]·exp(T_{n[h]})·S_{n[h]k}]” correspond to a lag-behind part in each X-ray detection signal. Thus, the apparatus in this embodiment derives the corrected, lag-free X-ray detection signal Xₖ promptly from equations A-E constituting a compact recurrence formula.

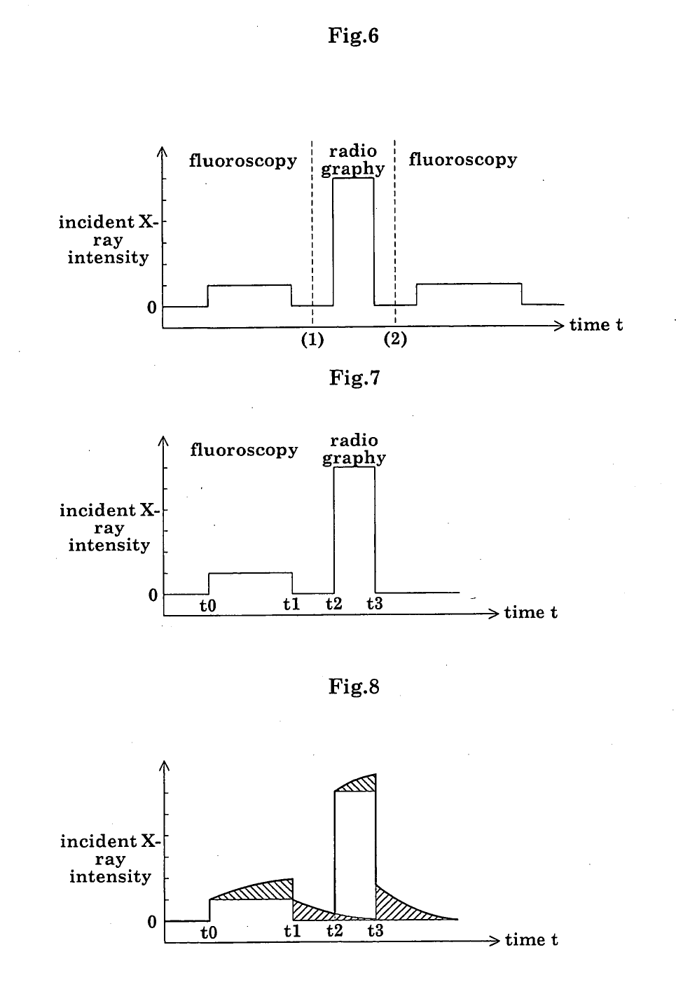

A specific image pickup situation in this embodiment will be described with reference to FIG. 6. FIG. 6 is a view showing a series of image pickup stages in X-ray radiography. In this embodiment, as shown in FIG. 6, a fluoroscopic image pickup event takes place based on an irradiation for fluoroscopy, which is followed by a radiographic image pickup event based on an irradiation for radiography, and a fluoroscopic image pickup event takes place again. The same dose (X-ray dose) is used in the fluoroscopic image pickup events before and after the radiographic image pickup event.

In this embodiment, there are two dose conditions, which are a dose condition for the fluoroscopic image pickup, and a dose condition for the radiographic image pickup. Thus, the number of doses H in equations A-E is set to 2, and “h” is set to 1 as the dose condition for the fluoroscopic image pickup, and to 2 as the dose condition for the radiographic image pickup. The number of exponential functions with different time constants forming the impulse response N[1] is set to 2, and the same N[2] is set to 2. Since the second term on the right-hand side of equation A corresponds to “α_{n[h]}·[1−exp(T_{n[h]})]·exp(T_{n[h]})·S_{n[k}]” integrated up to n[h]=1 to N[h], n[1] takes the values of 1 and 2, and n[2] takes the values of 1 and 2.

At this time, equation A becomes the following equation A1 in this embodiment. However, since, in equation A, α_{n[1]}≠α_{n[2]}, T_{n[1]}≠T_{n[2]} and S_{n[k]}≠S_{n[2]k}, modifications n[2]=1→3 and n[2]=2→4 are made for expediency of distinguishment from n[1]=1, 2 when Σ is developed.

$$\begin{matrix}{X}_{k} = {Y}_{k} - \{ {{\sum }_{n [ 1 ] = 1}}^{N [ 1 ]} [ {α}_{n [ 1 ]} \cdot [ 1 - exp ( {T}_{n [ 1 ]} ) ] \cdot exp ( {T}_{n [ 1 ]} ) \cdot {S}_{n [ 1 ] k} ] + \\ {{\sum }_{n [ 2 ] = 1}}^{N [ 2 ]} [ {α}_{n [ 2 ]} \cdot [ 1 - exp ( {T}_{n [ 2 ]} ) ] \cdot exp ( {T}_{n [ 2 ]} ) \cdot {S}_{n [ 2 ] k} ] \\ = {Y}_{k} - \{ {α}_{1} \cdot [ 1 - exp ( {T}_{1} ) ] \cdot exp ( {T}_{1} ) \cdot {S}_{1 k} + \\ {α}_{2} \cdot [ 1 - exp ( {T}_{2} ) ] \cdot exp ( {T}_{2} ) \cdot {S}_{2 k} + \\ {α}_{3} \cdot [ 1 - exp ( {T}_{3} ) ] \cdot exp ( {T}_{3} ) \cdot {S}_{3 k} + \\ {α}_{4} \cdot [ 1 - exp ( {T}_{4} ) ] \cdot exp ( {T}_{4} ) \cdot {S}_{4 k} \} \\ = {Y}_{k} - \{ {U}_{n [ 1 ]} + {U}_{n [ 2 ]} \} = {Y}_{k} - {\sum }_{h = 1}^{2} [ {U}_{n [ h ]} ]\end{matrix} \qquad A1$$

In this embodiment, equation B becomes the following equations B1 to B4, and equation E becomes the following equations E1 and E2 based on the above equation A1.

$$\begin{matrix}{T}_{1} = - Δ t / {τ}_{1} & B1 \\ {T}_{2} = - Δ t / {τ}_{2} & B2 \\ {T}_{3} = - Δ t / {τ}_{3} & B3 \\ {T}_{4} = - Δ t / {τ}_{4} & B4 \\ \begin{matrix}{U}_{n [ 1 ]} = {\sum }_{n [ 1 ] = 1}^{2} [ {α}_{n [ 1 ]} \cdot ( 1 - exp ( {T}_{n [ 1 ]} ) ] \cdot exp ( {T}_{n [ 1 ]} ) \cdot {S}_{n [ 1 ] k} ] \\ = {α}_{1} \cdot [ 1 - exp ( {T}_{1} ) ] \cdot exp ( {T}_{1} ) \cdot {S}_{1 k} + \\ {α}_{2} \cdot [ 1 - exp ( {T}_{2} ) ] \cdot exp ( {T}_{2} ) \cdot {S}_{2 k}\end{matrix} & E1 \\ \begin{matrix}{U}_{n [ 2 ]} = {\sum }_{n [ 2 ] = 1}^{2} [ {α}_{n [ 2 ]} \cdot ( 1 - exp ( {T}_{n [ 2 ]} ) ] \cdot exp ( {T}_{n [ 2 ]} ) \cdot {S}_{n [ 2 ] k} ] \\ = {α}_{3} \cdot [ 1 - exp ( {T}_{3} ) ] \cdot exp ( {T}_{3} ) \cdot {S}_{3 k} + \\ {α}_{4} \cdot [ 1 - exp ( {T}_{4} ) ] \cdot exp ( {T}_{4} ) \cdot {S}_{4 k}\end{matrix} & E2\end{matrix}$$

Equations C and D become the following equations C1-C4 and D1-D4 in this embodiment. With j=1 the image pickup is for fluoroscopy, and with j=2 the image pickup is for radiography.

In the fluoroscopic image pickup (j=1):
S₁ₖ=Xₖ₋₁+exp(T₁)·S₁₍ₖ₋₁₎ (in time of 1=h: component in fluoroscopy) C1
S₂ₖ=Xₖ₋₁+exp(T₂)·S₂₍ₖ₋₁₎ (in time of 1=h: component in fluoroscopy) C2
S₃ₖ=exp(T₃)·S₃₍ₖ₋₁₎ (in time of 1≠h: component in radiography) D1
S₄ₖ=exp(T₄)·S₄₍ₖ₋₁₎ (in time of 1≠h: component in radiography) D2

In the radiographic image pickup j=2):
S₁ₖ=exp(T₁)·S₁₍ₖ₋₁₎ (in time of 2≠h: component in fluoroscopy) D3
S₂ₖ=exp(T₂)·S₂₍ₖ₋₁₎ (in time of 2≠h: component in fluoroscopy) D4
S₃ₖ=Xₖ₋₁+exp(T₃)·S₃₍ₖ₋₁₎ (in time of 2=h: component in radiography) C3
S₄ₖ=Xₖ₋₁+exp(T₄)·S₄₍ₖ₋₁₎ (in time of 2=h: component in radiography) C4

Where a scaling before and after a change in the dose condition is taken into account, equations C and D become the following equations F and G with the scaling added thereto:
S_{n[j]i}=M·{Xᵢ₋₁+exp(T_{n[j]})·S_{n[j](i-1)}} (in time of j=h) F
S_{n[j]i}=exp(T_{n[j]})·S_{n[j](i-1)}} (in time of j≠h) G
where i−1: a subscript representing a point of time immediately before the dose change;
i: a subscript representing a point of time immediately after the dose change; and
M: a scaling ratio which is a ratio between values taken before and after the dose change.

The amplitude of X-ray tube 1 is switched when a change is made from the dose condition for the fluoroscopic image pickup to the dose condition for the radiographic image pickup ((1) in FIG. 6), and from the dose condition for the radiographic image pickup to the dose condition for the fluoroscopic image pickup ((2) in FIG. 6). In this embodiment, the dose for the radiographic image pickup is 30 times the dose for the fluoroscopic image pickup. Therefore, the scaling ratio M becomes 1/30 when a change is made from the fluoroscopic condition (the dose condition for the fluoroscopic image pickup) to the radiographic condition (the dose condition for the radiographic image pickup). The scaling ratio M becomes 30 when a change is made from the radiographic condition (the dose condition for the radiographic image pickup) to the fluoroscopic condition (the dose condition for the fluoroscopic image pickup).

Thus, when a change is made from the fluoroscopic condition to the radiographic condition ((1) in FIG. 6), and from the radiographic condition to the fluoroscopic condition ((2) in FIG. 6), equations F and G become the following equations F1-F4 and G1-G4:

When a change is made from the fluoroscopic condition to the radiographic condition ((1) in FIG. 6), M=1/30:
S₁ᵢ=M·{Xᵢ₋₁+exp(T₁)·S₁₍ᵢ₋₁₎} (in time of j=h: component in fluoroscopy) F1
S₂ᵢ=M·{Xᵢ₋₁+exp(T₂)·S₂₍ᵢ₋₁₎} (in time of j=h: component in fluoroscopy) F2
S₃ᵢ=exp(T₃)·S₃₍ᵢ₋₁₎} (in time of j≠h: component in radiography) G1
S₄ᵢ=exp(T₄)·S₄₍ᵢ₋₁₎} (in time of j≠h: component in radiography) G2

When a change is made from the radiographic condition to the fluoroscopic conditions ((2) in FIG. 6), M=30
S₁ᵢ=exp(T₁)·S₁₍ᵢ₋₁₎} (in time of j≠h: component in fluoroscopy) G3
S₂ᵢ=exp(T₂)·S₂₍ᵢ₋₁₎} (in time of j≠h: component in fluoroscopy) G4
S₃ᵢ=M·{Xᵢ₋₁+exp(T₃)·S₃₍ᵢ₋₁₎} (in time of j=h: component in radiography) F3
S₄ᵢ=M·{Xᵢ₋₁+exp(T₄)·S₄₍ᵢ₋₁₎} (in time of j=h: component in radiography) F4

In this embodiment, the analog-to-digital converter 3, detection signal processor 4, X-ray emission controller 6, irradiating and detecting system movement controller 9 and time delay remover 11 are operable on instructions and data inputted from an operating unit 12 or on various commands outputted from a main controller 13 with progress of X-ray radiography.

Next, an operation for performing X-ray radiography with the apparatus in this embodiment will particularly be described with reference to the drawings.

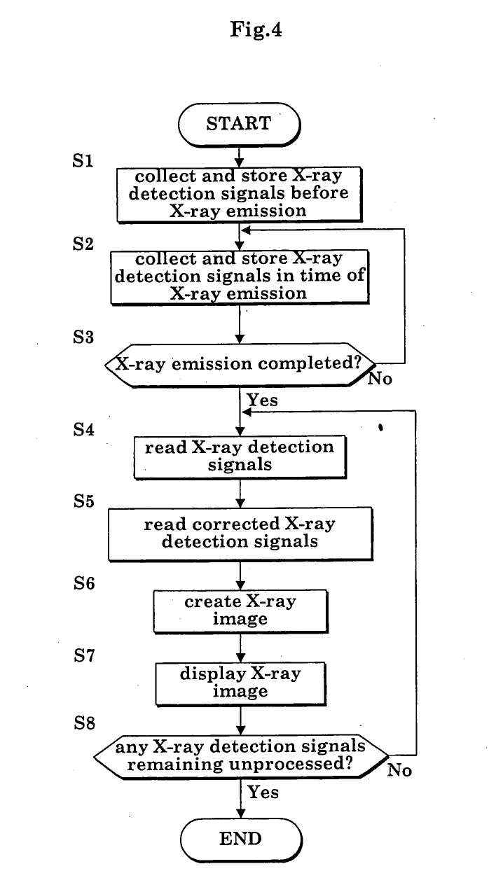

FIG. 4 is a flow chart showing a procedure of X-ray radiography in this embodiment. The radiography herein includes fluoroscopy.

[Step S1] The analog-to-digital converter 3 starts taking X-ray detection signals Yₖ for one X-ray image from the FPD 2 at each period between the sampling time intervals Δt (=1/30 second) before X-ray emission. The X-ray detection signals taken are stored in the memory 10.

[Step S2] In parallel with a continuous or intermittent X-ray emission to the patient M initiated by the operator, the analog-to-digital converter 3 continues taking X-ray detection signals Yₖ for one X-ray image at each period between the sampling time intervals At and storing the signals in the memory 10.

[Step S3] When the X-ray emission is completed, the operation proceeds to step S4. When the X-ray emission is uncompleted, the operation returns to step S2.

[Step S4] X-ray detection signals Yₖ for one X-ray image collected in one sampling sequence are read from the memory 10.

[Step S5] The time lag remover 11 performs the recursive computation based on the equations A-E (i.e. the foregoing equations A1-E2 in this embodiment), and derives corrected X-ray detection signals Xₖ, i.e. pixel values, with lag-behind parts removed from the respective X-ray detection signals Yₖ.

[Step S6] The detection signal processor 4 creates an X-ray image based on the corrected X-ray detection signals Xₖ for one sampling sequence (for one X-ray image).

[Step S7] The X-ray image created is displayed on the image monitor 5.

[Step S8] When unprocessed X-ray detection signals Yₖ remain in the memory 10, the operation returns to step S4. When no unprocessed X-ray detection signals Yₖ remain, the X-ray radiography is ended.

In this embodiment, the time lag remover 11 computes the corrected X-ray detection signals Xₖ corresponding to the X-ray detection signals Yₖ for one X-ray image, and the detection signal processor 4 creates an X-ray image, both at each period between the sampling time intervals Δt (=1/30 second). That is, the apparatus is constructed also for creating X-ray images one after another at a rate of about 30 images per second, and displaying the created X-ray images continuously. It is thus possible to perform a dynamic display of X-ray images.

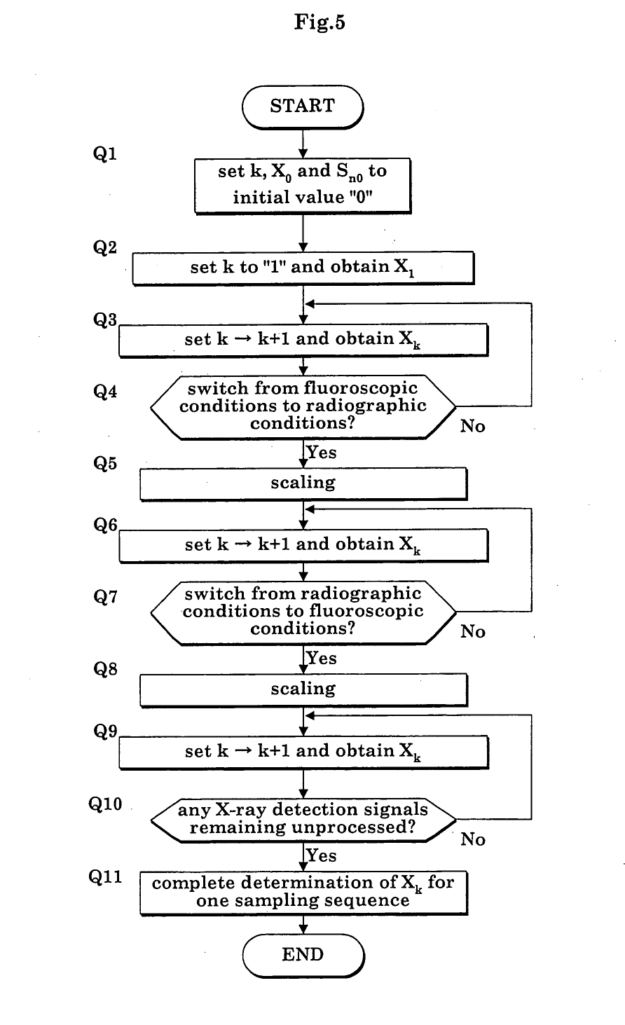

Next, the process of recursive computation carried out in step S5 in FIG. 4 by the time lag remover 11 will be described with reference to FIG. 5. FIG. 5 is a flow chart showing a recursive computation process for time lag removal in the radiation detection signal processing method in this embodiment.

[Step Q1] A setting k=0 is made, and X₀=0 in equation A1 and S₁₀=0, S₂₀=0, S₃₀=0 and S₄₀=0 in equations C1, C2, D1 and D2 are set as initial values before X-ray emission.

[Step Q2] In equations A1, C1, C2, D1 and D2, k=1 is set. S₁₁, S₂₁, S₃₁ and S₄₁ are derived from equations C1, C2, D1 and D2, i.e. S₁₁=X₀+exp(T₁)·S₁₀, S₂₁=X₀+exp(T₂)·S₂₀, S₃₁=X₀+exp(T₃)·S₃₀, and S₄₁=X₀+exp(T₄)·S₄₀. Further, corrected X-ray detection signal X1 is obtained by substituting S₁₁, S₂₁, S₃₁ and S₄₁ derived and X-ray detection signal Y₁ into equation A1. When a shift is made to X-ray emission (i.e. for fluoroscopic image pickup in this embodiment) at a point of time k=1, the FPD 2 provides detection signal Y₁ as a result of the X-ray emission. When a shift is made to X-ray emission at a point of time k=2 et seq., the FPD 2 provides detection signal Y₁ in a state of non-emission at the point of time k=1.

[Step Q3] After incrementing k by 1 (k=k+1) in equations A1, C1, C2, D1 and D2, Xₖ₋₁ of a preceding time is substituted into equations C1, C2, D1 and D2, thereby obtaining S₁ₖ, S₂ₖ, S₃ₖ and S₄ₖ. Further, corrected X-ray detection signal Xₖ is obtained by substituting S₁ₖ, S₂ₖ, S₃ₖ and S₄ₖ derived and X-ray detection signal Yₖ into equation A1.

[Step Q4] When the fluoroscopic image pickup is continued, the operation returns to step Q3. When switching is made from the fluoroscopic condition (i.e. the dose condition for the fluoroscopic image pickup) to the radiographic condition (i.e. the dose condition for the radiographic image pickup) ((1) in FIG. 6), the operation proceeds to the next step Q5.

[Step Q5] S₁ᵢ, S₂ᵢ, S₃ᵢ and S₄ᵢ are obtained by substituting M=1/30 and Xᵢ_{_{—}}₁ of k=i−1 (fluoroscopic condition) immediately before the switching into equations F1, F2, G1 and G2. Further, S₁ᵢ, S₂ᵢ, S₃ᵢ and S₄ᵢ obtained and X-ray detection signal Yᵢ of k=i (radiographic condition) immediately after the switching are substituted into equation A1, thereby obtaining corrected X-ray detection signal Xᵢ with the scaling taken into account. [Step Q6] After incrementing k by 1 (k=k+1) in equations A1, D3, D4, C3 and C4, Xₖ₋₁ of the preceding time is substituted into equations D3, D4, C3 and C4, thereby obtaining S₁ₖ, S₂ₖ, S₃ₖ and S₄ₖ. Further, corrected X-ray detection signal Xₖ is obtained by substituting S₁ₖ, S₂ₖ, S₃ₖ and S₄ₖ derived and X-ray detection signal Yₖ into equation A1.

[Step Q7] When the radiographic image pickup is continued, the operation returns to step Q6. When switching is made from the radiographic condition (i.e. the dose condition for the radiographic image pickup) to the fluoroscopic condition (i.e. the dose condition for the fluoroscopic image pickup) ((2) in FIG. 6), the operation proceeds to the next step Q8.

[Step Q8] S₁ᵢ, S₂ᵢ, S₃ᵢ and S₄ᵢ are obtained by substituting M=30 and Xᵢ₋₁ of k=i−1 (radiographic condition) immediately before the switching into equations G3, G4, F3 and F4. Further, S₁ᵢ, S₂ᵢ, S₃ᵢ and S₄ᵢ obtained and X-ray detection signal Yᵢ of k=i (fluoroscopic condition) immediately after the switching are substituted into equation A1, thereby obtaining corrected X-ray detection signal Xᵢ with the scaling taken into account.

[Step Q9] After incrementing k by 1 (k=k+1) in equations A1, C1, C2, D1 and D2, as in step Q3, Xₖ₋₁ of the preceding time is substituted into equations C1, C2, D1 and D2, thereby obtaining S₁ₖ, S₂ₖ, S₃ₖ and S₄ₖ. Further, corrected X-ray detection signal Xₖ is obtained by substituting S₁ₖ, S₂ₖ, S₃ₖ and S₄ₖ derived and X-ray detection signal Yₖ into equation A1.

[Step Q10] When there remain unprocessed X-ray detection signals Yₖ, the operation returns to step Q9. When no unprocessed X-ray detection signals Yₖ remain, the operation proceeds to the next step Q11.

[Step Q11] Corrected X-ray detection signals Xₖ for one sampling sequence (for one X-ray image) are obtained to complete the recursive computation for the one sampling sequence.

According to the fluoroscopic apparatus in this embodiment, as described above, impulse responses corresponding to the doses for the fluoroscopic image pickup and for the radiographic image pickup are used when the time lag remover 11 computes a corrected X-ray detection signal by removing a lag-behind part from each X-ray detection signal by the recursive computation. Thus, corrected X-ray detection signals are obtained with high accuracy. The corrected radiation detection signals are free from errors due to images picked up with the varied doses (with the fluoroscopic condition and radiographic condition), with the lag-behind parts fully removed therefrom.

In this embodiment, the corrected, lag-free X-ray detection signal Xₖ is derived promptly from equations A1-E2 constituting a compact recurrence formula. The number of dose types H is two (i.e. the fluoroscopic condition and radiographic condition). When an image is picked up at the current time k with condition h of one of the two doses, an impulse response corresponding to the other dose, while attenuating, will have an overlapping effect. That is, when an image is picked up under the fluoroscopic condition, an impulse response corresponding to the dose of the other, radiographic condition, while attenuating, will have an overlapping effect. When an image is picked up under the radiographic condition, an impulse response corresponding to the dose of the other, fluoroscopic condition, while attenuating, will have an overlapping effect. Thus, S₁ₖ, S₂ₖ, S₃ₖ and S₄ₖ are computed simultaneously as in equations C1-C4 and D1-D4 according to the respective doses, and corrected radiation detection signal Xₖ is computed by substituting S₁ₖ, S₂ₖ, S₃ₖ and S₄ₖ obtained into equation A1.

However, corrected radiation detection signal Xₖ, which is a veritable radiation detection signal, exists in time of j=h when an image is actually picked up, but does not exist in time of image pickup with the other dose when an image is not actually picked up, i.e. in time of j≠h. Thus, Xₖ is included in equations C1-C4, i.e. in time of j=h, and is not included in equations D1-D4, i.e. in time of j≠h. In this embodiment, an image is not actually picked up with the radiographic condition in time of fluoroscopic image pickup (j=1), and corrected radiation detection signal Xₖ does not exist at that time. Therefore, Xₖ is not included in equation D1 or D2 (in time of 1≠h), while Xₖ is included in equations C1 and C2 (in time of 1=h). Conversely, an image is not actually picked up with the fluoroscopic condition in time of radiographic image pickup (j=2), and corrected radiation detection signal Xₖ does not exist at that time. Therefore, Xₖ is not included in equation D3 or D4 (in time of 2≠h), while Xₖ is included in equations C3 and C4 (in time of 2=h). With such equations A1-E2, dose changes are taken into account for fully removing the lag-behind parts.

In this embodiment, before and after a switching of the radiation dose conditions k=i−1 and k=i, a scaling is performed based on scaling ratio M which is a ratio between values taken before and after the dose change. This produces the effect of removing the lag-behind parts with increased accuracy.

In this embodiment, lag-behind parts are sufficiently removed in a series of image pickup events including the fluoroscopic image pickup and radiographic image pickup using different X-ray doses.

This invention is not limited to the foregoing embodiment, but may be modified as follows:

(1) The embodiment described above employ an FPD as the radiation detecting device. This invention is applicable also to an apparatus having a radiation detecting device other than an FPD that causes time lags in X-ray detection signals.

(2) While the apparatus in the foregoing embodiment is a fluoroscopic apparatus, this invention is applicable also to an apparatus other than the fluoroscopic apparatus, such as an X-ray CT apparatus.

(3) The apparatus in the foregoing embodiment is designed for medical use. This invention is applicable not only to such medical apparatus but also to an apparatus for industrial use such as a nondestructive inspecting apparatus.

(4) The apparatus in the foregoing embodiment uses X rays as radiation. This invention is applicable also to an apparatus using radiation other than X rays.

(5) In the foregoing embodiment, the number of doses H in equations A-E is set to 2, h is set to 1 as the dose condition for fluoroscopic image pickup, and to 2 as the dose condition for radiographic image pickup, the number of exponential functions with different time constants forming the impulse response N[1] is set to 2, and the same N[2] is set to 2. The invention is not limited to these numbers.

For example, N[1] may be set to 1, 3 or more, and N[2] to 1, 3 or more. It is not necessary to set N[1] and N[2] to the same number. The number of doses H may be 3 or more. The number of doses H may be set to 3 where, for example, a dose of radiation (X-ray dose) for fluoroscopic image pickup before a radiographic image pickup event and a dose of radiation (X-ray dose) for fluoroscopic image pickup after the radiographic image pickup are made independent of each other. In this case, the fluoroscopic image pickup events may be based on the same dose or different doses.

(6) In the foregoing embodiment, a series of image pickups is performed from fluoroscopy to radiography and to fluoroscopy again. A series of image pickups may be performed from fluoroscopy to radiography of the head, from radiography of the head to radiography of the chest, from radiography of the chest to radiography of the abdomen, from radiography of the abdomen to radiography to the leg, and from the radiography of the leg to fluoroscopy. A series of image pickups may be performed from fluoroscopy to radiography only. That is, a series of image pickups may include at least a fluoroscopic image pickup event or events and a radiographic image pickup event or events.

(7) The foregoing embodiment concerns a series of image pickups including at least fluoroscopic image pickups and radiographic image pickups. The invention is not limited to this. A series of image pickups may include at least imaging of different sites using different doses of radiation. For example, different doses of radiation may be used for imaging different sites such as the head, chest, abdomen and leg, even in time of the same, fluoroscopic or radiographic image pickup. Lag-behind parts may be removed by taking each dose into account according to such a site to be imaged.

(8) In the foregoing embodiment, a scaling was performed when doses of radiation are changed. The scaling is not absolutely necessary where the scaling ratio is close to 1, or where no error will occur without performing the scaling.

This invention may be embodied in other specific forms without departing from the spirit or essential attributes thereof and, accordingly, reference should be made to the appended claims, rather than to the foregoing specification, as indicating the scope of the invention.

1. A radiographic apparatus having radiation emitting means for emitting radiation toward an object under examination, radiation detecting means for detecting radiation transmitted through the object under examination, and signal sampling means for taking radiation detection signals from the radiation detecting means at predetermined sampling time intervals, for obtaining radiographic images based on the radiation detection signals outputted from the radiation detecting means at the predetermined sampling time intervals as radiation is emitted to the object under examination, said apparatus comprising:
time lag removing means for removing lag-behind parts from the radiation detection signals by a recursive computation, on an assumption that a lag-behind part included in each of said radiation detection signals taken at the predetermined sampling time intervals is due to an impulse response formed of a plurality of exponential functions with different attenuation time constants;
wherein said time lag removing means is arranged to determine said impulse response based on a dose of radiation, and obtain a corrected radiation detection signal by removing the lag-behind part based on said impulse response corresponding to said dose.

2. A radiographic apparatus as defined in claim 1, wherein said time lag removing means is arranged to perform the recursive computation for removing the lag-behind part from each of the radiation detection signals, based on the following equations A-E:
$$\begin{matrix}\begin{matrix}{X}_{k} = {Y}_{k} - \{ {{\sum }_{n [ 1 ] = 1}}^{N [ 1 ]} [ {α}_{n [ 1 ]} \cdot [ 1 - exp ( {T}_{n [ 1 ]} ) ] \cdot exp ( {T}_{n [ 1 ]} ) \cdot {S}_{n [ 1 ] k} ] + \\ {{\sum }_{n [ 2 ] = 1}}^{N [ 2 ]} [ {α}_{n [ 2 ]} \cdot [ 1 - exp ( {T}_{n [ 2 ]} ) ] \cdot exp ( {T}_{n [ 2 ]} ) \cdot {S}_{n [ 2 ] k} ] + … + \\ {{\sum }_{n [ h ] = 1}}^{N [ h ]} [ {α}_{n [ h ]} \cdot [ 1 - exp ( {T}_{n [ h ]} ) ] \cdot exp ( {T}_{n [ h ]} ) \cdot {S}_{n [ h ] k} ] + … + \\ {{\sum }_{n [ H ] = 1}}^{N [ H ]} [ {α}_{n [ H ]} \cdot [ 1 - exp ( {T}_{n [ H ]} ) ] \cdot exp ( {T}_{n [ H ]} ) \cdot {S}_{n [ H ] k} ] + \} \\ = {Y}_{k} - \{ {U}_{n [ 1 ]} + {U}_{n [ 2 ]} + … + \\ {U}_{n [ h ]} … + {U}_{n [ H ]} \} = {Y}_{k} - {\sum }_{h = 1}^{H} [ {U}_{n [ h ]} ]\end{matrix} & A \\ {T}_{n [ h ]} = - Δ t / {τ}_{n [ h ]} & B \\ {S}_{n [ j ] k} = {X}_{k - 1} + exp ( {T}_{n [ j ]} ) \cdot {S}_{n [ j ] k - 1} ( in time of j = h ) & C \\ {S}_{n [ j ] k} = exp ( {T}_{n [ j ]} ) \cdot {S}_{n [ j ] k - 1} ( in time of j \neq h ) & D \\ {U}_{n [ h ]} = {\sum }_{n [ h ] = 1}^{N [ h ]} [ {α}_{n [ h ]} \cdot [ 1 - exp ( {T}_{n [ h ]} ) ] \cdot exp ( {T}_{n [ h ]} ) \cdot {S}_{n [ h ] k} ] & E\end{matrix}$$
where Δt: the sampling time interval;
k: a subscript representing a k-th point of time in a sampling time series;
Yₖ: an X-ray detection signal taken at the k-th sampling time;
Xₖ: a corrected X-ray detection signal with a lag-behind part removed from the signal Yₖ;
Xₖ₋₁: a signal Xₖ taken at a preceding point of time;
Sₙ₍ₖ₋₁₎: an Sₙₖ at a preceding point of time;
exp: an exponential function;
H: type of dose;
h: condition of a dose at a current point of time among H doses;
j: a subscript representing a given dose among the H doses;
N[h]: the number of exponential functions with different time constants forming the impulse response in time of dose h;
n[h]: a subscript representing one of the exponential functions forming the impulse response in time of dose h;
U_{n[h]}: a time lag in time of dose h;
α_{n[h]}: an intensity of exponential function n; and
τ_{n[h]}: an attenuation time constant of exponential function n;
and obtain the corrected radiation detection signal by removing the lag-behind part based on said impulse response derived from said equations A-E.

3. A radiographic apparatus as defined in claim 2, wherein a scaling before and after a change in conditions of the dose is performed based on the following equations F and G with the scaling added to said equations C and D:
S_{n[j]i}=M·{Xᵢ₋₁+exp(T_{n[j]})·S_{n[j](i-1)} (in time of j=h) F
S_{n[j]i}=exp(T_{n[j]})·S_{n[j](i-1)}} (in time of j≠h) G
where i−1: a subscript representing a point of time immediately before the dose change;
i: a subscript representing a point of time immediately after the dose change; and
M: a scaling ratio which is a ratio between values taken before and after the dose change.

4. A radiographic apparatus as defined in claim 1, wherein said radiation detecting means is a flat panel X-ray detector having numerous X-ray detecting elements arranged longitudinally and transversely on an X-ray detecting surface.

5. A radiographic apparatus as defined in claim 1, wherein said apparatus is a medical apparatus.

6. A radiographic apparatus as defined in claim 5, wherein said medical apparatus is a fluoroscopic apparatus.

7. A radiographic apparatus as defined in claim 5, wherein said medical apparatus is an X-ray CT apparatus.

8. A radiographic apparatus as defined in claim 1, wherein said apparatus is for industrial use.

9. A radiographic apparatus as defined in claim 8, wherein said apparatus for industrial use is a nondestructive inspecting apparatus.

10. A radiation detection signal processing method for taking, at predetermined sampling time intervals, radiation detection signals generated by irradiating an object under examination, and performing a signal processing to obtain radiographic images based on the radiation detection signals outputted at the predetermined sampling time intervals, said method comprising the steps of:
removing lag-behind parts from the radiation detection signals by a recursive computation, on an assumption that a lag-behind part included in each of said radiation detection signals taken at the predetermined sampling time intervals is due to an impulse response formed of a plurality of exponential functions with different attenuation time constants;
determining said impulse response based on a dose of radiation; and
obtaining a corrected radiation detection signal by removing the lag-behind part based on said impulse response corresponding to said dose.

11. A radiation detection signal processing method as defined in claim 10, wherein the recursive computation is performed for removing the lag-behind part from each of the radiation detection signals, based on the following equations A-E:
$$\begin{matrix}\begin{matrix}{X}_{k} = {Y}_{k} - \{ {{\sum }_{n [ 1 ] = 1}}^{N [ 1 ]} [ {α}_{n [ 1 ]} \cdot [ 1 - exp ( {T}_{n [ 1 ]} ) ] \cdot exp ( {T}_{n [ 1 ]} ) \cdot {S}_{n [ 1 ] k} ] + \\ {{\sum }_{n [ 2 ] = 1}}^{N [ 2 ]} [ {α}_{n [ 2 ]} \cdot [ 1 - exp ( {T}_{n [ 2 ]} ) ] \cdot exp ( {T}_{n [ 2 ]} ) \cdot {S}_{n [ 2 ] k} ] + … + \\ {{\sum }_{n [ h ] = 1}}^{N [ h ]} [ {α}_{n [ h ]} \cdot [ 1 - exp ( {T}_{n [ h ]} ) ] \cdot exp ( {T}_{n [ h ]} ) \cdot {S}_{n [ h ] k} ] + … + \\ {{\sum }_{n [ H ] = 1}}^{N [ H ]} [ {α}_{n [ H ]} \cdot [ 1 - exp ( {T}_{n [ H ]} ) ] \cdot exp ( {T}_{n [ H ]} ) \cdot {S}_{n [ H ] k} ] + \} \\ = {Y}_{k} - \{ {U}_{n [ 1 ]} + {U}_{n [ 2 ]} + … + \\ {U}_{n [ h ]} … + {U}_{n [ H ]} \} = {Y}_{k} - {\sum }_{h = 1}^{H} [ {U}_{n [ h ]} ]\end{matrix} & A \\ {T}_{n [ h ]} = - Δ t / {τ}_{n [ h ]} & B \\ {S}_{n [ j ] k} = {X}_{k - 1} + exp ( {T}_{n [ j ]} ) \cdot {S}_{n [ j ] k - 1} ( in time of j = h ) & C \\ {S}_{n [ j ] k} = exp ( {T}_{n [ j ]} ) \cdot {S}_{n [ j ] k - 1} ( in time of j \neq h ) & D \\ {U}_{n [ h ]} = {\sum }_{n [ h ] = 1}^{N [ h ]} [ {α}_{n [ h ]} \cdot [ 1 - exp ( {T}_{n [ h ]} ) ] \cdot exp ( {T}_{n [ h ]} ) \cdot {S}_{n [ h ] k} ] & E\end{matrix}$$
where Δt: the sampling time interval;
k: a subscript representing a k-th point of time in a sampling time series;
Yₖ: an X-ray detection signal taken at the k-th sampling time;
Xₖ: a corrected X-ray detection signal with a lag-behind part removed from the signal Yₖ;
Xₖ₋₁: a signal Xₖ taken at a preceding point of time;
Sₙ₍ₖ₋₁₎: an Sₙₖ at a preceding point of time;
exp: an exponential function;
H: type of dose;
h: condition of a dose at a current point of time among H doses;
j: a subscript representing a given dose among the H doses;
N[h]: the number of exponential functions with different time constants forming the impulse response in time of dose h;
n[h]: a subscript representing one of the exponential functions forming the impulse response in time of dose h;
U_{n[h]}: a time lag in time of dose h;
α_{n[h]}: an intensity of exponential function n; and
τ_{n[h]}: an attenuation time constant of exponential function n;
and the corrected radiation detection signal is obtained by removing the lag-behind part based on said impulse response derived from said equations A-E.

12. A radiation detection signal processing method as defined in claim 11, wherein a scaling before and after a change in conditions of the dose is performed based on the following equations F and G with the scaling added to said equations C and D:
S_{n[j]i}=M·{Xᵢ₋₁+exp(T_{n[j]})·S_{n[j](i-1)}} (in time of j=h) F
S_{n[j]i}=exp(T_{n[j]})·S_{n[j](i-1)}} (in time of j≠h) G
where i−1: a subscript representing a point of time immediately before the dose change;
i: a subscript representing a point of time immediately after the dose change; and
M: a scaling ratio which is a ratio between values taken before and after the dose change.

13. A radiation detection signal processing method as defined in claim 10, wherein a series of image pickups including at least a fluoroscopic image pickup and a radiographic image pickup using different doses of radiation is performed, said impulse response being determined from the dose of radiation for each image pickup, and the corrected radiation detection signal being obtained by removing the lag-behind part based on said impulse response corresponding to said dose, thereby obtaining radiographic images.

14. A radiation detection signal processing method as defined in claim 10, wherein a series of image pickups including at least imaging of different sites using different doses of radiation is performed, said impulse response being determined from the dose of radiation for each image pickup, and the corrected radiation detection signal being obtained by removing the lag-behind part based on said impulse response corresponding to said dose, thereby obtaining radiographic images.

15. A radiation detection signal processing method as defined in claim 13, wherein said series of image pickups is performed in an order from fluoroscopy to radiography and to fluoroscopy again.

16. A radiation detection signal processing method as defined in claim 15, wherein said series of image pickups is performed in an order from fluoroscopy to radiography of the head, from radiography of the head to radiography of the chest, from radiography of the chest to radiography of the abdomen, from radiography of the abdomen to radiography to the leg, and from the radiography of the leg to fluoroscopy.

17. A radiation detection signal processing method as defined in claim 13, wherein said series of image pickups is performed in an order from fluoroscopy to radiography only.

18. A radiation detection signal processing method as defined in claim 14, wherein said different sites are the head, chest, abdomen and leg.

19. A radiation detection signal processing method as defined in claim 13, wherein a switching is made between said fluoroscopic image pickup and said radiographic image pickup by switching amplitudes of radiation emitting means for emitting radiation toward the object under examination.
